(19) United States
(12) Patent Application Publication
(10) Pub. No.: US 2016/0136698 A1
(43) Pub. Date: May 19, 2016

(54) SHAKABLE CLEANING BAG

(71) Applicant: Harrison Richard Kaufman, Eureka, CA (US)

(72) Inventor: Harrison Richard Kaufman, Eureka, CA (US)

(21) Appl. No.: 14/304,447

(22) Filed: Jun. 13, 2014

Related U.S. Application Data
(63) Continuation-in-part of application No. 13/108,974, filed on May 16, 2011, now Pat. No. 8,789,546.

(51) Int. Cl. B08B 3/10

(52) U.S. Cl. CPC B08B 3/102

(57) ABSTRACT

A shakable cleaning bag is disclosed. The shakable cleaning bag may clean a plurality of objects that includes a base cleaning bag, a cleaning pouch disposed in the base cleaning bag that receives the objects to be cleaned and a perforated cut line disposed on the top portion of the base cleaning bag that is cut when the base cleaning bag is ready to be utilized. A fastener disposed below the perforated cut line that runs across the base cleaning bag allowing access to the cleaning pouch and an abrasive or non-abrasive alcohol cleaning solution that is contained in the base cleaning bag that has direct contact with the objects that are placed in the base cleaning bag to be cleaned by the alcohol cleaning solution. There is also a two pouch base cleaning bag with a rinsing pouch and rinse solution and a method of use.

The present application is a Continuation-In-Part Application of U.S. Non-Provisional patent application Ser. No. 13/108,974 filed on May 16, 2011, the entire disclosure of which is incorporated by reference.

### TECHNICAL FIELD & BACKGROUND

It is an object of the present invention to provide a single pouch shakable cleaning bag to clean a variety of objects that is self-contained, clean, reusable and easy to use.

Dentures and similar products need to be soaked clean and sometimes need a little more abrasive cleaning attention. In traditional denture cleaning jar packaging a user may only soak dentures. Other cleaners may be in a rigid traditional bottle with a jar lid top. What is needed is a soft flexible package that allows a user to shake dentures or items to be cleaned without making damaging contact against the jar.

### BRIEF SUMMARY OF THE INVENTION

It is an object of the present invention to provide a single pouch shakable cleaning bag to clean a variety of objects that is self-contained, clean, reusable and easy to use.

The shakable cleaning bag includes a base cleaning bag with a top portion, an interior and a front, a cleaning pouch disposed in the interior of the base cleaning bag that receives the objects to be cleaned and a perforated cut line disposed on the top portion of the base cleaning bag that is cut when the base cleaning bag is ready to be utilized. The shakable cleaning bag includes a fastener disposed below the perforated cut line that runs across the front of the base cleaning bag allowing access to the cleaning pouch and an cleaning solution that is contained in the base cleaning bag that has direct contact with the objects that are placed in the base cleaning bag to be cleaned by the cleaning solution.

It is an object of the present invention to provide a shakable cleaning bag with a cleaning pouch portion and a rinsing pouch portion to clean a variety of objects that is self-contained, clean, reusable and easy to use.

It is an object of the present invention to provide a shakable cleaning bag to provide a self-contained, clean and easy to use cleaning method for cleaning one or more dirty smoking utensils, one or more tool components, one or more firearms components and jewelry.

It is an object of the present invention to provide a shakable cleaning bag to clean difficult to clean one or more dentures, one or more partials and one or more orthodontic parts.

It is an object of the present invention to provide a shakable cleaning bag that utilizes a reusable and resealable plastic bag or ZIPLOC® with a sealed top to contain a liquid cleaning product that is shaken and contains one or more dentures, one or more partials and one or more orthodontic parts that are cleaned within the shakable cleaning bag.

It is an object of the present invention to provide a shakable cleaning bag that is utilized in combination with an effervescent denture cleaner to clean one or more dentures, one or more partials and one or more orthodontic parts that are cleaned within the shakable cleaning bag.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a side environmental perspective view of a shakable cleaning bag, in accordance with one embodiment of the present invention.

FIG. 2 illustrates a side environmental perspective view of a shakable cleaning bag, in accordance with one embodiment of the present invention.

FIG. 3A and FIG. 3B illustrates a flow chart of a method for using a shakable cleaning bag, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

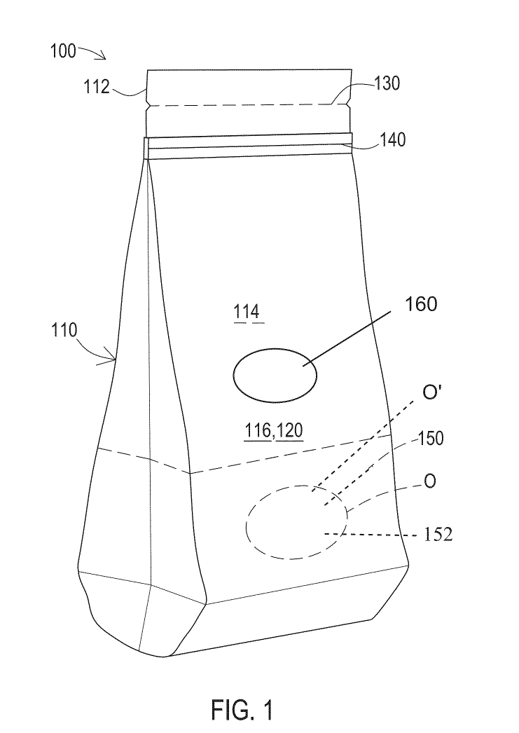

FIG. 1 illustrates a side environmental perspective view of a shakable cleaning bag 100, in accordance with one embodiment of the present invention.

The shakable cleaning bag 100 may include a base cleaning bag 110, a cleaning pouch 120, a perforated cut line 130, a tongue and groove fastener 140, a cleaning solution 150 and a transparent window 160. The shakable cleaning bag 100 may provide a single pouch shakable cleaning bag to clean a variety of objects that may be self-contained, clean, reusable and easy to use.

The base cleaning bag 110 may have a top portion 112, an interior 114 and a front 116. The base cleaning bag 110 may be made of heavy duty transparent plastic, although the base cleaning bag 110 may be made of heavy duty foil as well as other suitable material. The cleaning pouch 120 may be disposed in the interior 114 of the base cleaning bag 110 and may receive objects O to be cleaned, degreased and/or disinfected. The objects O may include one or more dirty smoking utensils, one or more tool components, one or more firearms components, jewelry, one or more dentures, one or more partials and one or more orthodontic parts and other suitable objects. The perforated cut line 130 may be disposed on the top portion 112 of the base cleaning bag 110 and may be cut when the base cleaning bag 110 is ready to be utilized. The perforated cut line 130 may run across the entire front 116 of the base cleaning bag 110. The tongue and groove fastener 140 may be disposed below the perforated cut line 130 and may be accessed, opened and resealed as desired once the perforated cut line 130 has been cut. The tongue and groove fastener 140 may also run across the entire front 116 of the base cleaning bag 110, allowing access to the cleaning pouch 120.

The cleaning solution 150 may be an abrasive or non-abrasive alcohol solution that may be contained in the base cleaning bag 110 and has direct contact with the objects O that may be placed in the base cleaning bag 110 to be cleaned. The cleaning solution 150 may be an effervescent denture cleaner 152 that may be soluble in a liquid such as water or other suitable liquid. The cleaning solution 150 may be contained in the cleaning pouch 120 to soak the objects O may be placed in the base cleaning bag 110 to be cleaned. The effervescent denture cleaner 152 may be in a tablet form, a powder form or other suitable form. Once the objects O may be placed in the base cleaning bag 110 to be cleaned, the shakable cleaning bag 100 may be vigorously shaken for approximately 1 minute or other predetermined suitable period of time. Once the shaking may be stopped, the objects O may be rinsed with water and are cleaned and are ready to be reutilized. The cleaning solution 150 may be reutilized or recycled as desired and may be any suitable solution. The cleaning solution 150 may also degrease and disinfect any objects O being cleaned. The transparent window 160 may be disposed on the base cleaning bag 110 to allow a user to view what is inside of the base cleaning bag 110. The transparent window 160 may be made of transparent plastic or other suitable material.

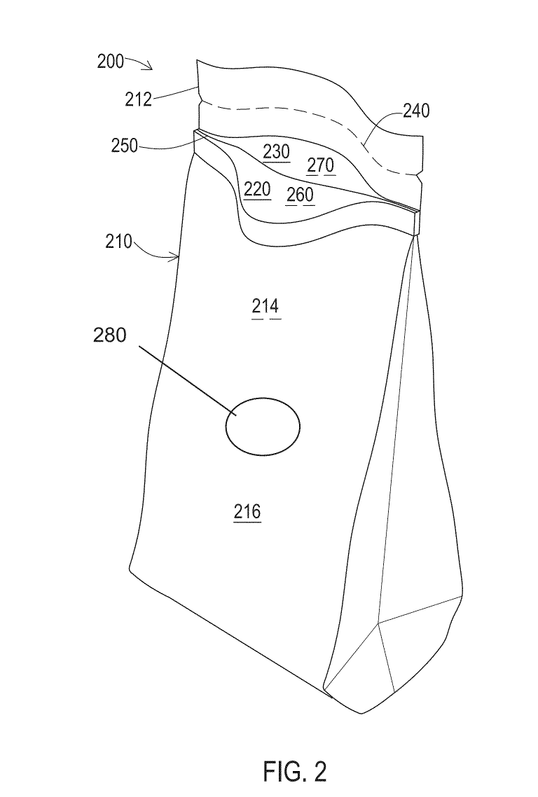

FIG. 2 illustrates a side environmental perspective view of a shakable cleaning bag 200, in accordance with one embodiment of the present invention.

The shakable cleaning bag 200 may include a base cleaning bag 210, a cleaning pouch 220, a rinsing pouch 230, a perforated cut line 240, a tongue and groove fastener 250, a cleaning solution 260, a rinsing solution 270 and a transparent window 280.

The base cleaning bag 210 may have a top portion 212, an interior 214 and a front 216. The base cleaning bag 210 may be made of heavy duty transparent plastic, although the base cleaning bag 210 may be made of heavy duty foil as well as other suitable material. The cleaning pouch 220 may be disposed in the interior 214 of the base cleaning bag 210 and receives objects O to be cleaned, degreased and/or disinfected. The rinsing pouch 230 may be disposed in the interior 214 of the base cleaning bag 210 adjacent to the cleaning pouch 220. The perforated cut line 240 may be disposed on the top portion 212 of the base cleaning bag 210 and may be cut when the base cleaning bag 210 may be ready to be utilized. The perforated cut line 240 may run across the entire front 216 of the base cleaning bag 210. The tongue and groove fastener 250 may be disposed below the perforated cut line 240 and may be accessed, opened and resealed as desired once the perforated cut line 240 has been cut. The tongue and groove fastener 250 may also run across the entire front 216 of the base cleaning bag 210, allowing access to the cleaning pouch 220 and the rinsing pouch 230.

The cleaning solution 260 may be an abrasive or non-abrasive alcohol solution that may be contained in the base cleaning bag 210 and has direct contact with the objects O that may be placed in the base cleaning bag 210 to be cleaned. Once the objects O may be placed in the base cleaning bag 210 to be cleaned, the shakable cleaning bag 200 may be vigorously shaken for approximately 1 minute or other suitable predetermined period of time. Once the shaken may be stopped, the objects O may be rinsed with water and may be cleaned and are ready to be reutilized. The cleaning solution 260 may be reutilized or recycled as desired and may be any suitable solution. The cleaning solution 260 may also degrease and disinfect any objects O being cleaned. The rinsing solution 270 may be water or any other suitable rinsing solution. The objects O may include one or more dirty dentures, one or more partials and or orthodontic gear that need cleaning (FIG. 1, O′). The objects O may be rinsed in the rinsing solution 270 after they have been cleaned in the cleaning solution 260. The transparent window 280 may be disposed on the base cleaning bag 210 to allow a user to view what is inside of the base cleaning bag 210. The transparent window 280 may be made of transparent plastic or other suitable material.

The base cleaning bag may contain a cleaning solution featuring a resealable ZIPLOC® top intended for inserting dirty worn dentures and oral products, retainers, mouth guards and soaking and/or shaking to agitate a cleaner for the purpose of cleaning, disinfecting and freshening the items to be stored in the base cleaning bag. The base cleaning bag may also have a transparent plastic viewing window for a user to view what is inside of the base cleaning bag.

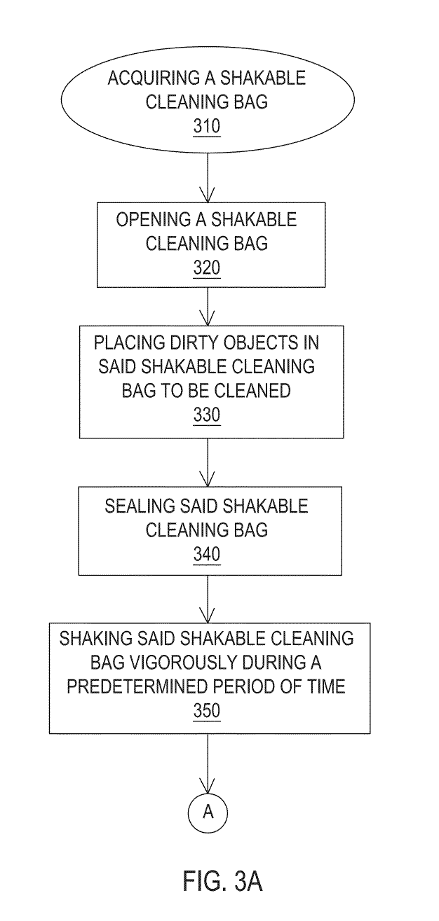

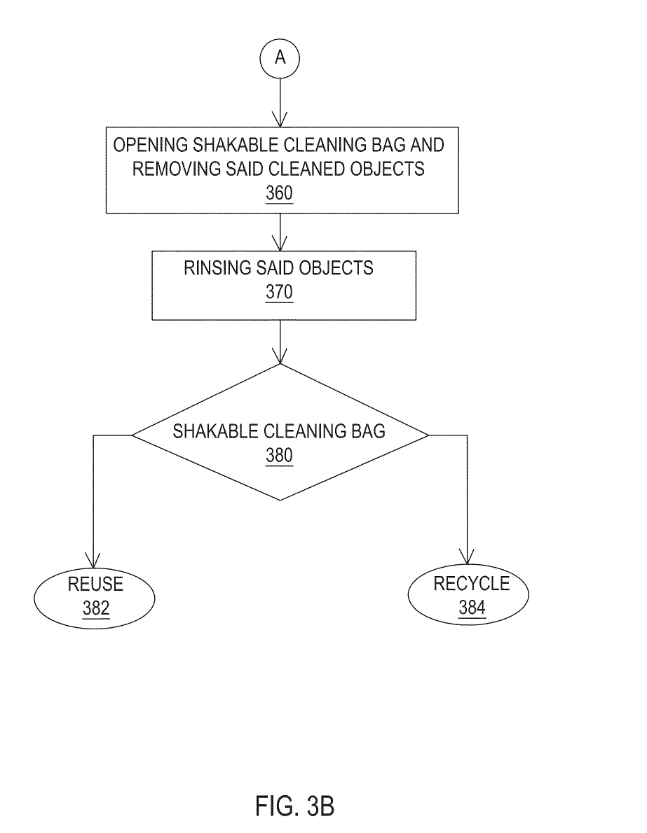

FIG. 3A illustrates a flow chart of a method 300 for using a shakable cleaning bag, in accordance with one embodiment of the present invention.

The method 300 may include acquiring a shakable cleaning bag 310, opening a shakable cleaning bag 320, placing dirty objects in the shakable cleaning bag to be cleaned 330, sealing the shakable bag 340 and shaking the shakable cleaning bag vigorously during a predetermined period of time 350.

Acquiring the shakable cleaning bag 310 may be acquired from any suitable shakable cleaning bag source, such as a hardware store. Opening the shakable bag 320 may include cutting a perforated cutting line and opening a tongue and groove fastener. Placing dirty objects in the shakable cleaning bag to be cleaned 330 may include objects such as one or more dirty smoking utensils, one or more tool components, one or more firearms components and jewelry and other suitable objects being placed typically by hand into the shakable cleaning bag. Sealing the shakable bag 340 may include closing the tongue and groove fastener. Shaking the shakable cleaning bag vigorously during a predetermined period of time 350 may involve grasping the shakable cleaning bag anywhere on the shakable cleaning bag and shaking vigorously for approximately 1 minute or any other suitable predetermined period of time to clean the objects.

FIG. 3B illustrates a flow chart of a method 300 for using a shakable cleaning bag, in accordance with one embodiment of the present invention.

The method 300 may include opening shakable cleaning bag and removing the cleaned objects 360, rinsing the objects 370 and reusing 382 or discarding 384 the shakable cleaning bag 380.

Opening the shakable cleaning bag and removing the cleaned objects 360 may involve opening the tongue and groove fastener and removing the cleaned objects. Rinsing the objects 370 may be done within the shakable cleaning bag if there is a rinsing pouch. If there is no rinsing pouch, then the objects may be rinsed outside of the shakable cleaning bag, typically with water or other suitable rinsing liquid.

The method for utilizing a shakable cleaning bag may cut or pull open the initial bag at the indicated arrows on the top of the shakable cleaning bag. The ZIPLOC® liner may be pulled open to insert one or more dirty dentures, one or more partials and or orthodontic gear that need cleaning.

While the present invention has been related in terms of the foregoing embodiments, those skilled in the art will recognize that the present invention is not limited to the embodiments described. The present invention may be practiced with modification and alteration within the spirit and scope of the appended claims. Thus, the description is to be regarded as illustrative instead of restrictive on the present invention.

1. A shakable cleaning bag to clean a plurality of objects, comprising:
a base cleaning bag with a top portion, an interior and a front;
a cleaning pouch disposed in the interior of the base cleaning bag that receives the objects to be cleaned;
a perforated cut line disposed on the top portion of the base cleaning bag that is cut when the base cleaning bag is ready to be utilized;
a fastener disposed below the perforated cut line that runs across the front of the base cleaning bag allowing access to the cleaning pouch;
a cleaning solution contained in the base cleaning bag that has direct contact with the objects that are placed in the base cleaning bag to be cleaned by the cleaning solution; and
a transparent window disposed on the base cleaning bag, the transparent window allows a user to view what is inside of the base cleaning bag.

2. The cleaning bag according to claim 1, wherein the cleaning bag is made of heavy duty transparent plastic.

3. The cleaning bag according to claim 1, wherein the cleaning bag is made of heavy duty foil.

4. The cleaning bag according to claim 1, wherein the fastener is a tongue and groove fastener.

5. The cleaning bag according to claim 1, wherein the cleaning solution is an effervescent denture cleaner in tablet form or powder form.

6. The cleaning bag according to claim 1, wherein the cleaning solution is a non-abrasive alcohol solution or an abrasive alcohol solution.

7. The cleaning bag according to claim 1, wherein the cleaning solution is contained in the cleaning pouch to soak the objects placed in the base cleaning bag to be cleaned.

8. The cleaning bag according to claim 1, wherein the objects are selected from the group consisting of one or more dirty smoking utensils, one or more tool components, one or more firearms components, jewelry, one or more dirty dentures, one or more partials or orthodontic gear.

9. The cleaning bag according to claim 1, wherein the objects are degreased and disinfected.

10. The cleaning bag according to claim 1, wherein the transparent window is made of transparent plastic.

11. A shakable cleaning bag to clean a plurality of objects, comprising:
a base cleaning bag with a top portion, an interior and a front;
a cleaning pouch disposed in the interior of the base cleaning bag that receives the objects to be cleaned;
a rinsing pouch disposed in the interior of the base cleaning bag adjacent to the cleaning pouch;
a perforated cut line disposed on the top portion of the base cleaning bag that is cut when the base cleaning bag is ready to be utilized;
a fastener disposed below the perforated cut line that runs across the front of the base cleaning bag allowing access to the cleaning pouch and the rinsing pouch;
a cleaning solution contained in the base cleaning bag that has direct contact with the objects that are placed in the base cleaning bag to be cleaned by the cleaning solution;
a rinsing solution contained in the rinsing pouch that has direct contact with the objects that have been cleaned in the cleaning bag by the cleaning solution to rinse the cleaned objects; and
a transparent window disposed on the base cleaning bag, the transparent window allows a user to view what is inside of the base cleaning bag.

12. The cleaning bag according to claim 11, wherein the cleaning bag is made of heavy duty transparent plastic.

13. The cleaning bag according to claim 11, wherein the cleaning bag is made of heavy duty foil.

14. The cleaning bag according to claim 11, wherein the fastener is a tongue and groove fastener.

15. The cleaning bag according to claim 11, wherein the cleaning solution is an effervescent denture cleaner in tablet form or powder form.

16. The cleaning bag according to claim 11, wherein the cleaning solution is a non-abrasive alcohol solution or an abrasive alcohol solution.

17. The cleaning bag according to claim 11, wherein the rinsing solution is water.

18. The cleaning bag according to claim 11, wherein the objects are selected from the group consisting of one or more dirty smoking utensils, one or more tool components, one or more firearms components, jewelry, one or more dirty dentures, one or more partials or orthodontic gear.

19. The cleaning bag according to claim 11, wherein the cleaning solution is contained in the cleaning pouch to soak the objects placed in the base cleaning bag to be cleaned.

20. The cleaning bag according to claim 11, wherein the transparent window is made of transparent plastic.
